(19) United States
(12) Patent Application Publication
(10) Pub. No.: US 2003/0162580 A1
(43) Pub. Date: Aug. 28, 2003

(54) Lottery ticket-communication device gaming system

(76) Inventors: Emmanuele Cousineau, Outremont (CA); John Connelly, Montreal (CA)

Correspondence Address: WATOV & KIPNES, P.C., P.O. Box 247, Princeton Junction, NJ, 08550, US

(21) Appl. No.: 10/364,752

(22) Filed: Feb. 11, 2003

Related U.S. Application Data
(60) Provisional application No. 60/356,325, filed on Feb. 12, 2002.

(51) Int. Cl. G06F 17/00

(52) U.S. Cl. 463/17

(57) ABSTRACT

A lottery ticket gaming system in which at least one function of the game played on the lottery ticket is performed by obtaining information regarding the same by a communication device which places the player in communication with the lottery sponsor.

### FIELD OF THE INVENTION

The present invention is generally directed to a gaming system which employs a printed lottery ticket and a communication device in which the player contacts a lottery sponsor or party licensed by the lottery sponsor and receives information relevant to performing a function which is necessary to play at least one of the games appearing in a play area on the printed lottery ticket.

### BACKGROUND OF THE INVENTION

Lottery tickets are well known and have been played by a significant number of players in the United States and other countries of the world. One type of lottery ticket enables the player to select a finite group of numbers from a universe of such numbers and wait to hear whether at least a minimum number of the select numbers are chosen by a lottery sponsor such as a National or State Lottery Commission in which case the lottery ticket may be a winning ticket.

Other types of lottery tickets are scratch-off type lottery tickets which have games printed on the lottery ticket itself. The play area comprising a plurality of play indicia is covered by a scratch-off layer and the player, in accordance with the rules of the game, removes all or a portion of the scratch-off layer covering the play area. If a minimum number of play indicia or a certain pattern of play indicia appear beneath the scratch-off layer, a prize may be won.

There has been a growing trend to introduce lottery tickets in which the type of game or play action involves more than just waiting to see if select numbers are chosen by the lottery sponsor or, in connection with scratch-off lottery tickets, to require more than merely removing a scratch-off layer to immediately determine whether a prize has been won.

One such effort involves employing probability games as part of the lottery ticket wherein the player has some choice of how to play the games or the numbers that are selected. Another type of game provides a series of step-by-step instructions to play the game by which the player moves about the play area in an effort to win a prize.

It would therefore be a significant advance in the art of lottery tickets to provide an additional form of entertainment as part of the lottery game to make the lottery ticket more interesting to play and to have the player more involved in the playing of the game.

### SUMMARY OF THE INVENTION

The present invention is generally directed to a lottery ticket gaming system which combines a lottery ticket which may be purchased at a conventional lottery ticket retail agent and a communication device in which the player employs the communication device to interface with a sponsor of the lottery ticket or a party licensed by the lottery sponsor to obtain necessary information for the player to participate in the playing of the lottery game. As a result of such a system, playing of the game is facilitated by the combination of a printed lottery ticket and communication with the lottery sponsor through the communication device.

In a particular aspect of the present invention, there is provided a lottery ticket gaming system comprising:

a) a lottery ticket containing instructions for employing a communication device to interface with a sponsor of the lottery ticket or licensee of the lottery sponsor;

b) means enabling the communication device to interface with the sponsor of the lottery ticket or licensee of the lottery sponsor, wherein the communication device is employed to connect the player with the lottery sponsor or licensee thereof to enable the player to obtain information relevant to performing a function which is necessary to participate in at least one lottery game.

In a preferred form of the present invention, the communication device is a telephone, most preferably a mobile telephone and the instructions for employing the communication device includes at least one telephone number to enable operative contact by the player with the lottery sponsor or party licensed by the lottery sponsor.

In a further preferred form of the invention, the lottery ticket contains initiating indicia which is transmitted by the player to the lottery sponsor or licensee thereof through the communication device which, if verified by the lottery sponsor as valid, enables the player to play a lottery game.

In a further preferred form of the invention, the lottery ticket comprises at least one play area containing a conventional scratch-off type lottery game.

In a further preferred form of the invention, the lottery ticket comprises at least two play areas, at least one of the play areas comprising a conventional lottery game such as a scratch-off lottery game while at least one other play area provides the instructions for the player to interface with the lottery sponsor and participate in a lottery game through the communication device.

### BRIEF DESCRIPTION OF THE DRAWINGS

The following drawings in which like reference characters indicate like parts are illustrative of embodiments of the invention and are not intended to limit the invention as encompassed by the claims forming part of the application.

FIG. 1 is a top view of an embodiment of a lottery ticket employed in the present invention with a single play area for playing a game through the use of a communication device;

FIG. 2 is a top view of another embodiment of a lottery ticket employed in the present invention with one conventional play area in the form of a conventional lottery ticket and a second play area for playing a game through the use of a communication device;

FIG. 3 is a schematic view of an embodiment of a gaming system of the present invention employing a printed lottery ticket of the type shown in FIG. 1 and a telephone as the communication device; and

FIG. 4 is a schematic view of another embodiment of the gaming system of the present invention.

### DETAILED DESCRIPTION OF THE INVENTION

The present invention is generally directed to a gaming system employing a lottery ticket containing instructions which enables the player to communicate with the lottery sponsor or licensee thereof through a communication device to play at least one game which may typically include a lottery type game.

The lottery ticket may include a conventional type lottery game such as finding a minimum number of desired indicia from a preselected number of indicia such as may typically be found in a conventional scratch-off ticket game. Of particular importance to the present invention is the employment of a communication device such as a telephone, preferably a mobile telephone, instant messaging device, pager or the like to communicate with a lottery sponsor or licensee thereof (hereinafter “lottery sponsor”) to obtain information relevant to the playing of at least one of the lottery games.

Referring to FIG. 1, there is shown a first embodiment of a lottery ticket 2 for use in the present invention comprising a substrate 4 having a code area 6 including initiating indicia 8 such as at least one number or letter typically covered by a conventional opaque scratch-off layer typically made of a removable latex (not shown).

The code area 6 also contains communication indicia 10 such as a telephone number to be used when the communication device is, for example, a telephone such as a mobile telephone. The initiating indicia 8 is transmittable by the player through the communication device to the lottery sponsor by dialing the communication indicia 10 (i.e. the number 72310) shown specifically in FIG. 1.

Beneath the code area 6 is an authenticating indicia area 11 containing authenticating indicia (not shown) covered by a scratch-off layer 12 which when removed can be manually or automatically (read through an optical scanning device) entered into a lottery sponsor authentication apparatus for connection to a lottery sponsor database. If the authenticating indicia is recognized by the database, the lottery ticket may be authenticated to enable payout of any prize that may be won.

The player who purchases the lottery ticket of FIG. 1 initiates the game activity by uncovering the scratch-off layer (not shown) hiding the initiating indicia 8 (i.e. BGNFTO as shown specifically in FIG. 1) in the code area 6. The player sends the initiating indicia 8, using a communication device such as a mobile phone text messenger (SMS), via the telephone number (e.g. 72310 as shown in FIG. 1, which is a so called short number, but may also be a typical telephone number). The telephone number may also be a voice telephone number, with an IVR-application. When the lottery sponsor database receives the initiating indicia 8, it verifies that the initiating indicia 8 is a valid code, and if valid, the lottery sponsor initiates playing of the game e.g. a quiz game where the player is asked a series of questions.

It will be understood that the game played through the lottery ticket 2 shown in FIG. 1 may be any type of game so long as instructions for playing the game and the player's ability to play the game may be transmitted through the communication device.

For example, the game may take the form of a question and answer game whereby the lottery sponsor poses at least one question which if answered correctly may result in a prize being won. Another such example may be a number game. For example, the lottery sponsor asks a player to identify a number within a range of, for example, between 1 and 100 by giving the player the opportunity for a predetermined number of guesses. If the player identifies the number, a prize may be won.

As previously indicated any communication device that may provide operable communication between the player and the lottery sponsor may be used. Such communication devices include telephones (e.g. mobile phones) instant messengers, palm pilots, pagers and the like.

The lottery ticket may be bought in a conventional lottery retail outlet typically managed by a lottery ticket agent. Prizes may be collected in a like manner. Alternatively, the cost of the lottery ticket and credits for winning prizes may be credited or debited to a player's telephone account through a registered standard credit card and/or through a private account established for the player directly or indirectly through the lottery sponsor.

In another aspect of the present invention, there is provided a lottery ticket as described above in connection with FIG. 1 which also includes a conventional lottery ticket game which may be played without employing of the communication device.

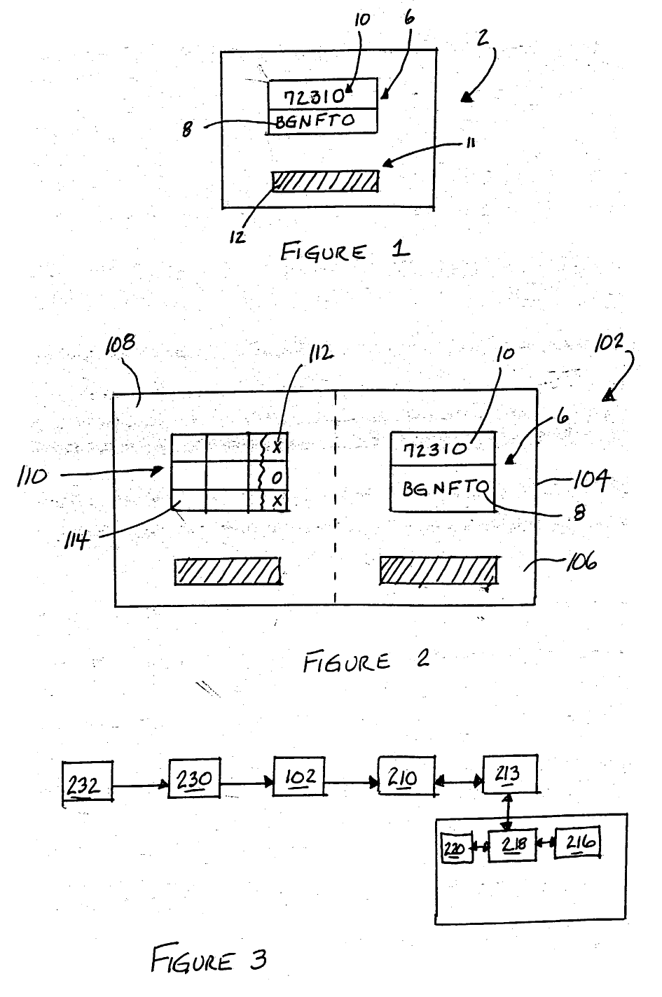

Referring to FIG. 2, there is shown a lottery ticket 102 for use in the present invention comprising a substrate 104 having a first ticket portion 106 and a second ticket portion 108. The second ticket portion 108 can comprise at least one standard lottery ticket game such as a standard scratch-off game 110 in which game indicia 112 are covered by a scratch-off layer 114. A prize may be won if the game indicia 112 completes a pattern in accordance with the rules of the game (e.g. three of the same symbol are uncovered to win a prize).

Positioned beneath the scratch-off game 110 is an authenticating indicia area 111 containing authenticating indicia (not shown) covered by a scratch-off layer 116 which when removed can be manually or automatically (through an optical scanning device) entered into a lottery sponsor authentication apparatus for connection to a lottery sponsor database to authenticate the scratch-off game and any prize that may be won in a conventional manner.

The first ticket portion 106 is essentially the same as the lottery ticket 2 described in connection with FIG. 1. There is provided a code area 6 including initiating indicia 8 which is transmitted to the lottery sponsor through the communication device by dialing the communication indicia 10.

As previously indicated, below the code area 6 is an authentication area 11 preferably containing the same authentication indicia as appears in the second ticket portion 108 in the authentication area 111 beneath the scratch-off layer 116. This preferred arrangement provides an advantage such that a prize can be paid out exactly in the same way for the second ticket portion 108 as for the first ticket portion game 106, i.e. the prize is paid from a retailer on-line terminal, where the authentication indicia (e.g. bar code) is read and authenticated in a known on-line system. In one embodiment of the invention, the authentication indicia in the first and second ticket portions is a bar code version of the initiating indicia 8 (e.g. a bar code which “reads” BGNFTO).

The lottery ticket described in connection with FIG. 2 and particularly the first ticket portion 106 is played by employing a lottery ticket communication device which enables the player to interface with a lottery sponsor or licensee of the lottery sponsor to complete at least one lottery game in the second ticket portion including the determination of whether a prize has been won.

It will be understood that the second lottery ticket portion 108 and the scratch-off game 110 contained therein is an optional but preferred feature of the present invention because it does serve to provide an added form of amusement to the lottery ticket in addition to the game played in connection with the first ticket portion as described previously in connection with FIG. 1.

An embodiment of the lottery ticket gaming system of the present invention is shown in FIG. 3 wherein a lottery sponsor 232 such as a National or State Lottery Commission or the like provides a series of retail agents 230 to sell lottery tickets 102 as shown in FIG. 2 to players. The lottery ticket 102 includes as previously described in connection with FIG. 2 a second ticket portion 108 having a standard scratch-off game 110 thereon and a second ticket portion 106 including instructions for communicating with the lottery sponsor via a communication device as previously described.

In one embodiment of the invention, the lottery ticket 102 (see FIG. 2) may be provided with a code area 6 including initiating indicia 8 (see FIG. 2) which may be covered by a scratch-off layer. The code area 6 has printed thereon communication indicia 10 such as a telephone number which is to be dialed by the player using a telephone 210 as shown in FIG. 3 as a representative example of a communication device useful in the present invention. The telephone number may be limited to a number which is sufficient to provide only telecommunication with a server 214 via a network operator 213 or may be a number that provides both telecommunication and information sufficient to enable the server 214 to identify the ticket and verify that it is a proper ticket (e.g. a pin number). If the telephone number is for telecommunication only, the player will be asked to provide a serial number or pin number from the lottery ticket to enable the lottery sponsor to authenticate the lottery ticket as suitable for playing the lottery game. The pin number may be printed anywhere on the lottery ticket and will typically be covered by a scratch-off layer.

The lottery ticket 102 may include as previously described authentication indicia such as a bar code which may optionally be covered by a scratch-off layer 12. The bar code may be used by a lottery ticket agent when the lottery ticket is redeemed to claim a prize as an additional means of authenticating the lottery ticket as proper and that a prize may be properly claimed.

The server 214 is controlled by a lottery sponsor which may be for example a State or National Lottery Commission or may be a private company which may be licensed by the lottery sponsor.

In accordance with the present invention, at least one aspect of the playing of the lottery game will involve the use of a communication device such as a telephone (e.g. a mobile telephone) and communication with a lottery sponsor such as a state lottery commission or licensee thereof. In the embodiment described herein, a mobile telephone is used as an example of a communication device. When the telephone number obtained from the lottery ticket or from some other source is dialed, the player will be connected to the server 214 typically through an operator network 213. The server 214 includes a verification unit 216 and a data processing unit 218 which will typically contain an instruction server. Data for operating the game and verifying tickets comes from a central database 220. When a voice connection is made, the server 214 will verify the lottery ticket from the telephone number or request the player to identify a serial number or other indicia (e.g. pin number) of the lottery ticket to enable verification that the lottery ticket is a proper ticket. The verification unit 216 obtains this information via the database 220 through the data processing unit 218.

Once proper verification is made, the lottery ticket will be identified based on information contained in the database 220 and matched with instructions from the data processing unit 218.

The type of instruction provided for the instruction server contained within the data processing unit 218 may include any instructions which is necessary for the player to complete the game played and determine if a prize has been won. In this regard, the instructions may include information for playing the game on the first and/or second ticket portion, information related to whether or not a prize has been won, information related to the amount of any prize that may be won, or may include information relative to the playing of a bonus game on the lottery ticket (not shown) or the like. What is essential to the present invention, is that the communication device (e.g. telephone) becomes an integral part of the playing of a lottery game which is reference to the lottery ticket and provides additional entertainment for the player.

In a further embodiment of the invention, the lottery ticket 102 as shown in FIG. 2 requires that the player remove the scratch-off layer from the game area 110 to reveal play indicia 112. Instead of having a prize determination area for specifically determining whether a prize has been as is typically for scratch-off type lottery tickets won and/or the amount of the prize as shown in the lottery ticket of FIG. 2, the player employs the telephone number for contacting the server 214 through the network operator 213 as described above in connection with FIG. 2. Once contact is made with through the server 214, the player is provided with information that tells the player whether or not the game which is played has produced a winning lottery ticket and the amount of any such prize. Accordingly, the employment of the telephone and the resulting contact with the server 214 enables the player to complete a function necessary for completing the lottery game printed on the lottery ticket.

If the player has a winning lottery ticket, then the lottery ticket is brought to a lottery agent and the lottery agent may separately verify whether the ticket is a winning ticket by inserting the lottery ticket into an authentication apparatus where it reads the indicia (e.g. bar code).

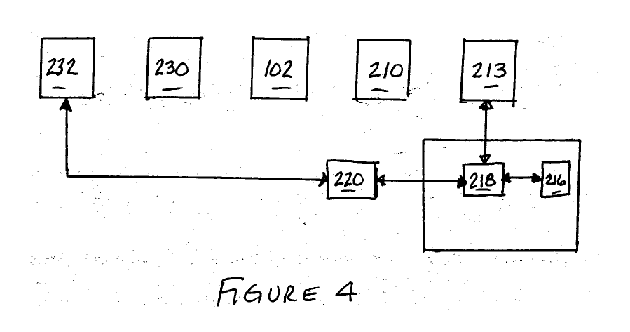

In a further embodiment of the invention as shown in FIG. 4, the server 214 includes the verification unit 216, the data processing 218 which may be owned and controlled by one party having a license from a lottery sponsor such as a National or State Lottery Commission. However, unlike the embodiment shown in FIG. 3, the database 220 remains under control of the lottery sponsor and is linked to the server 214 of a party under license with the State or National Lottery Commission.

Other embodiments of the present invention would become apparent to those of ordinary skill in the art including the use of the telephone to obtain information about playing a bonus game or to provide information about an additional play indicia which may be available to the player or the like.

What is claimed is:

1. A lottery ticket gaming system comprising:
a) a lottery ticket containing instructions for employing a communication device to interface with a sponsor of the lottery ticket; and
b) means enabling the communication device to interface with a sponsor of the lottery ticket, wherein the communication device is employed to connect the player with the lottery sponsor to enable the player to obtain information to perform a function necessary to participate in at least one lottery game.

2. The lottery ticket gaming system of claim 1 wherein connection with the lottery sponsor enables the player to perform a function to complete at least one game appearing on the lottery ticket.

3. The lottery ticket gaming system of claim 1 wherein the lottery ticket comprises a first ticket portion comprising initiating indicia which is transmitted by the player to the lottery sponsor through the communication device.

4. The lottery ticket gaming system of claim 3 wherein the initiating indicia comprise numbers or letters or combinations thereof.

5. The lottery ticket gaming system of claim 1 wherein the communication device is selected from the group consisting of a telephone, an instant messenger, a pager, a palm pilot and combinations thereof.

6. The lottery ticket gaming system of claim 1 wherein the communication device is a mobile telephone.

7. The lottery ticket gaming system of claim 1 wherein the initiating indicia is covered by a scratch-off layer.

8. The lottery ticket gaming system of claim 1 further comprising authenticating indicia for authenticating the lottery ticket.

9. The lottery ticket gaming system of claim 8 wherein the authenticating indicia is covered by a scratch-off layer.

10. The lottery ticket gaming system of claim 1 further comprising at least one standard lottery ticket game.

11. The lottery ticket gaming system of claim 10 comprising a second ticket portion containing at least one scratch-off lottery game.

12. The lottery ticket gaming system of claim 1 wherein the connection with the lottery sponsor through the communication device enables the player to perform at least one function to play a game associated with the lottery ticket.

13. The lottery ticket gaming system of claim 1 wherein connection with the lottery sponsor through the communication device enables the player to perform a function to determine if a prize has been won.

14. The lottery ticket gaming system of claim 1 further comprising a network operator for receiving a communication signal from the communication device and transmitting the same to a lottery server.

15. The lottery ticket gaming system of claim 15 wherein the lottery server comprises a verification unit, a data processing unit, and a database.

16. The lottery ticket gaming system of claim 16 wherein the verification unit comprises means for verifying that a lottery ticket is a proper lottery ticket.

17. The lottery ticket gaming system of claim 17 wherein the instruction unit relays the information from the database to the player necessary to perform said function.

18. The lottery ticket gaming system of claim 17 wherein the server is controlled by a licensee of the lottery sponsor.

19. The lottery ticket gaming system of claim 17 wherein the database is controlled by the lottery sponsor.

20. The lottery ticket gaming system of claim 1 wherein the at least one lottery game includes at least one bonus game.
